(19) United States
(12) Patent Application Publication
(10) Pub. No.: US 2003/0043028 A1
(43) Pub. Date: Mar. 6, 2003

(54) Home network system

(76) Inventors: Yuji Torikai, Hyogo (JP); Ikuko Sasaki, Hyogo (JP); Katsumi Kitagaki, Hyogo (JP)

Correspondence Address: BURNS, DOANE, SWECKER & MATHIS, L.L.P., P.O. Box 1404, Alexandria, VA, 22313-1404, US

(21) Appl. No.: 10/193,324

(22) Filed: Jul. 12, 2002

(30) Foreign Application Priority Data
Aug. 30, 2001 (JP) 2001-261757

(51) Int. Cl. H04M 11/04

(52) U.S. Cl. 340/310.01; 340/5.1

(57) ABSTRACT

A receptacle 1 is provided with insertion detecting means 14 for detecting the connection of a device 2, a memory 12 for storing therein a house code, and a power line superposition communication means 11 for superposing the house code on a power line 4. The house code is automatically set in the device 2 when the device 2 is connected to the receptacle 1.

### BACKGROUND OF THE INVENTION

1. Field of the Invention

This invention is related to a home network system in which, in the home network communication using a power line, a house code previously stored in a receptacle is accurately and automatically set in each terminal, thereby preventing interference with a neighboring house, and lightening the workload imposed on the user required for establishing the network.

2. Description of Related Art

As one of the communication methods for implementing a home network, there is a power line superposition method. In this method, since information is distributed to the power line connected to the device on the sending side, the signal (the above information) is also sent to a neighboring household's power line, and if there is no information identifying a destination, the device in the neighboring house will be malfunctioned. To solve such a problem, if information (data or the like) is sent by power line superposition, a house code specifying (limiting) a destination should be appended thereto.

Although there are several house codes, the X10 protocol, one of the power line superposition methods, will be explained here by way of example.

FIG. 9 is an explanatory drawing showing the data structure to be superposed on a power line in the X10 protocol. As shown in FIG. 9, the X10 protocol consists of START CODE indicative of the beginning of communication data, HOUSE CODE identifying a house, and KEY CODE. The contents of the KEY CODE include NUMBER CODE identifying a device, and FUNCTION CODE requesting ON/OFF or the status of a device, and NUMBER CODE or FUNCTION CODE makes the communication data as KEY CODE. FIG. 10 is an explanatory drawing showing an example of HOUSE CODE and KEY CODE. As shown in FIG. 10, HOUSE CODE (hereinafter referred to as house code) is defined so that it can set 4-bits codes A to P to identify each home. Further, KEY CODE (hereinafter referred to as device code) consists of 5 bits, and each code is defined for identifying a device or setting a function and operation.

For communication using the X10 protocol, a dedicated module is used on both the sending and receiving sides. FIG. 11 is a perspective view showing a general view of the module. In FIG. 11, reference numeral 100 denotes a module, reference numeral 101 a dial for setting a device code, and reference numeral 102 a dial for setting a house code. In the module 100 connected to a device on the receiving side, an arbitrary device code is set by the dial 101, and a house code representing the “house” of the user is set by the dial 102. The user uses the module 100 on the receiving side to set the device code of a target device for operation setting with the dial 101, and the house code of the “house” where the device is installed with the dial 102. The modules 100 on the sending and receiving sides are set previously in this way, and if the house and device codes sent by power line superposition match the settings on the receiving side module 100, the receiving side module 100 takes in the command (for instance, the above FUNCTION CODE) transmitted along with the house code, and a predetermined processing is executed in the device.

The conventional house code settings include two kinds of method. One is a manual setting by the user of the switch and the like provided in a device as in the module 100 shown by way of example, and another is an automatic setting of a host device which manages the network of the house by determining a house code, and by automatically communicating with that device at the time of installing a device newly provided in the home.

The conventional home network system is constructed as above. In the method in which a house code is manually set, the user first needs to set a house code for each device, resulting in a considerable workload. Further, a wrong house code is very likely set by a user's mistake. Furthermore, in the method in which a house code is automatically set by the host device, a house code superposed on the power line also reaches a neighboring house or the like. Thus, at the time of installing a newly provided device, it is possible that communication is performed between the host device of the neighboring house, and that the house code of the neighboring house is set, so a wrong house code might be set in this manner.

### SUMMARY OF THE INVENTION

This invention has been made to solve the above problems, and an object thereof is to provide a home network system in which the workload imposed on the user is lightened, a house code is automatically set in each device, and the house code is accurately set, thereby preventing the malfunction of the device to increase the reliability of security.

The home network system according to the invention includes a receptacle for power supply for superposing a house code previously assigned for each home on a power line upon detection of the insertion of a power cord plug, and a terminal for receiving the house code superposed on the power line after the insertion of the power cord plug, and setting it as the house code thereof.

According to the invention, since there is provided a receptacle for power supply for superposing a house code previously assigned for each home on a power line upon detection of the insertion of a power cord plug, and a terminal for receiving the house code superposed on the power line after the insertion of the power cord plug, and setting it as the house code thereof, the house code can automatically be set in a newly connected terminal to lighten the workload imposed on the user, and the accurate house code can be set, thereby preventing the malfunction of the terminal.

The home network system according to the invention includes a terminal for superposing on a power line a house code request command requesting the sending of the house code previously assigned for each home by insertion of the power code plug, and a receptacle for power supply for superposing the house code on the power line, when it detects the insertion of the power cord plug and receives the house code request command superposed on the power line, wherein the terminal receives the house code superposed on the power line, and sets it as the house code thereof.

According to the invention, since there are provided a terminal for superposing on a power line a house code request command requesting the sending of the house code previously assigned for each home by insertion of the power cord plug, and a receptacle for power supply for superposing the house code on the power line, when it detects the insertion of the power cord plug and receives the house code request command superposed on the power line, and the terminal receives the house code superposed on the power line and sets it as the house code thereof, the house code can be sent from the receptacle to the terminal when the terminal is in a state ready for setting of the house code, and the house code can be set in the terminal with reliability.

The home network system according to the invention includes, in a receptacle, insertion detecting means for detecting the insertion of a power cord plug, memory means for storing therein a house code previously assigned for each home, power line superposition communication means for performing communication through a power line, and control means for reading the house code stored in the memory when the insertion detecting means detects the insertion of the power cord plug and the power line superposition communication means receives a house code request command superposed on the power line, and superposing the read house code on the power line by using the power line superposition means.

According to the invention, since there are provided, in a receptacle, insertion detecting means for detecting the insertion of a power cord plug, memory means for storing therein a house code previously assigned for each home, power line superposition communication means for performing communication through a power line, and control means for reading the house code stored in the memory when the insertion detecting means detects the insertion of the power cord plug and the power line superposition communication means receives a house code request command superposed on the power line, and superposing the read house code on the power line by using the power line superposition means, the house code can reliably be set in the terminal whose power cord plug is connected to the receptacle.

The home network system according to the invention includes a receptacle for power supply for superposing the house code previously assigned for each home on a power line upon detection of the insertion of a power cord plug, a host terminal for receiving the house code superposed on the power line, comparing it with the house code held by the host terminal, and superposing the house code and the setting data necessary for registration to the home network on the power line when the received house code is the same as the house code held by the host terminal, and a terminal for receiving the house code and the setting data superposed on the power line by the host terminal after the insertion of the power cord plug, setting it as the house code thereof, and performing the setting necessary for registration to the home network.

According to the invention, since there are provided a receptacle for power supply for superposing the house code previously assigned for each home on a power line upon detection of the insertion of a power cord plug, a host terminal for receiving the house code superposed on the power line, comparing it with the house code held by the host terminal, and superposing the house code and the setting data necessary for registration to the home network on the power line when the received house code is the same as the house code held by the host terminal, and a terminal for receiving the house code and the setting data superposed on the power line by the host terminal after the insertion of the power cord plug, setting it as the house code thereof, and performing the setting necessary for registration of the home network, the accurate house code can be set in the terminal, and the newly connected terminal can automatically be registered in the host terminal.

### BRIEF DESCRIPTION OF THE DRAWINGS

FIG. 1 is a schematic block diagram showing the configuration of the home network system according to a first embodiment of the invention;

FIG. 2 is an explanatory drawing showing the connection of the receptacle and a device;

FIG. 3 is a block diagram showing the construction of the receptacle;

FIG. 4 is an explanatory drawing showing the insertion detecting means;

FIG. 5 is an explanatory drawing showing the insertion detecting means;

FIG. 6 is an explanatory drawing showing the connection of a receptacle and a device according to a second embodiment of the invention;

FIG. 7 is an explanatory drawing showing the communication and connection between receptacles, a device, and a host device according to a third embodiment of the invention;

FIG. 8 is a flowchart showing the home network communication method performed between the device, receptacle, and host device according to the third embodiment;

FIG. 9 is an explanatory drawing showing the X10 protocol used in the conventional home network communication;

FIG. 10 is an explanatory drawing showing the HOUSE CODE and KEY CODE of the X10 protocol; and

FIG. 11 is a perspective view showing the general view of the module used in the X10 protocol communication.

### DETAILED DESCRIPTION OF THE PREFERRED EMBODIMENT

The embodiments of the invention will now be described in detail with reference to the attached drawings.

### First Embodiment

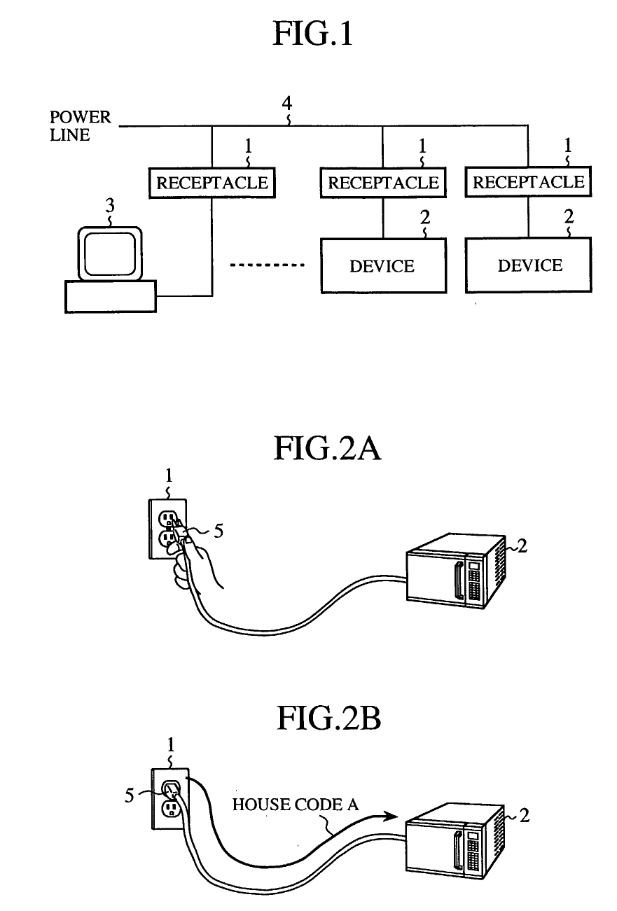

FIG. 1 is a schematic block diagram showing the configuration of the home network system according to the first embodiment of the invention.

Referring to FIG. 1, reference numeral 1 denotes a receptacle for power supply provided in houses (not shown), reference numeral 2 various devices (terminals) provided with a function (power line superposition communication means) capable of performing home network communication through a power line, and reference numeral 3 a host device (host terminal) consisting of, for instance, a personal computer, which recognizes the device 2, and manages ON/OFF of the power supply and the status of the device 2. The host device 3 is not necessarily provided in the same house as the device 2. Reference numeral 4 denotes a power line connected to each receptacle 1 for supplying power to the house. Although a communication system based on the X10 protocol is taken as an example and described in this home network system, another communication protocol may be used as long as a similar effect is obtained, and the example shown here gives no limitation.

The communication performed between the receptacle 1 and a device 2, when the device 2 is newly connected to the home network, will be described.

FIG. 2 is an explanatory drawing showing the communication state when the receptacle 1 and the device 2 are connected. In the second embodiment, like reference numerals as FIG. 1 indicate like components.

Referring to FIG. 2, reference numeral 5 denotes a power cord plug for power supply provided in the device 2, and reference numeral A a house code assigned for each home. As shown in FIG. 2A, when the power cord plug 5 is newly connected to the receptacle 1 for the device 2 which unregistered in the home network, the receptacle 1 detects the connection of the power cord plug 5, as shown in FIG. 2B, and superposes the stored house code A on the power line 4 by using a power line communication modem to be described later. The house code A is taken into the device 2 by a power line superposition interface (power line superposition communication means) provided in the device 2 during a predetermined time in which the device 2 is in a receiving state since the connection of the power cord plug 5 to the receptacle 1.

Further, in the above description, when the host device 3 is connected to the receptacle 3 instead of the device 2, the house code A stored in the receptacle 1 is also installed in the host device 3, and the setting operation for establishing the home network promotes reduction in the workload imposed on the user.

The construction of the receptacle 1 will then be described.

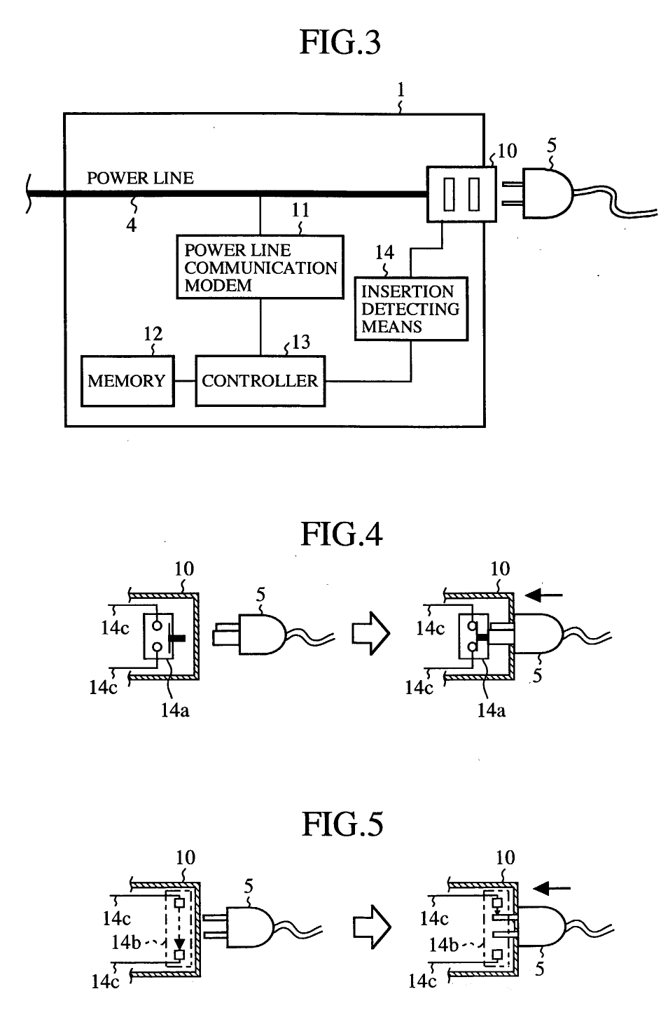

FIG. 3 is a block diagram showing the construction of the receptacle 1.

Referring to FIG. 3, reference numeral 10 denotes a connecting member formed thereon insertion holes into which the contact pieces of the power cord plug 5 are inserted, and reference numeral 11 a power line communication modem (power line superposition communication means) for superposing and sending each data on the power line 4, and receiving the data superposed on the power line 4. Reference numeral 12 denotes a memory (memory means) having stored previously therein the house code A assigned for each home, for instance, at the time of building the house, reference numeral 13 a controller (control means) for performing data communication through the power line communication modem 11, and reference numeral 14 insertion detecting means for detecting whether or not the power cord plug 5 is inserted into the connecting member 10.

Now, the operation of the home network system of the first embodiment will be described.

When the power cord plug 5 of the device 2 is inserted into the receptacle 1 shown in FIG. 3, the insertion detecting means 14 detects the contact member of the power cord plug 5 inserted into the connecting member 10, and outputs the detected result to the controller 13. For the detection of the power cord plug 5 by the insertion detecting means 14, three different means are used. That is, a mechanical means in which a switch or the like is put in contact with the power cord plug 5, a means in which the insertion of the power cord plug 5 is detected by an optical sensor or the like having no moving mechanism, or a means having no moving mechanism in which the impedance change of the power line 4 caused by the connection of the power cord plug 5 (device 2) to the power cord plug 4.

The controller 13 having recognized the insertion (connection) of the power cord plug 5 reads the house code A previously stored in the memory 12 (for instance, at the time of building the house), and outputs it to the power line 4 for superposition by using the power line communication modem 11 (it is needless to say that the power line 4 is in a state ready for power supply at this point of time). The device 2 having the power cord plug 5 connected to the receptacle 1 takes in the house code A superposed on the power line 4 through the power line superposition interface (not shown), and installs (sets) it as the house code thereof. This installation is allowed only for a predetermined time since the connection of the power cord plug 5 to the receptacle 1 by the device 2. When another house code is outputted from some device (or a receptacle having a functional construction similar to the receptacle 1) provided in a neighboring house to the power line 4, it must be bewared not to take in by mistake.

In this way, the device 2 automatically acquires the house code A when the power cord plug 5 is connected to the receptacle 1, and thereafter, in communication on the home network, the information communication and mutual setting between each device are performed by using this house code A (if the X10 protocol is adopted, a start code, a function code for specifying/recognizing the device 2 or setting the operation of the device 2, and the like as well as the house code A is appended as information to be communicated). This information communication and mutual setting also allow each setting (such as registration to the network) performed between the host device 3 and the device 2 as shown in FIG. 1.

The construction and operation of the insertion detecting means 14 for detecting the insertion (connection) of the power cord plug 5 will then be described.

FIG. 4 is an explanatory drawing showing the diagrammatic cross section of the insertion detecting means 14 built in the connecting member 10.

Referring to FIG. 14, reference numeral 14a denotes a switch that is an example of the insertion detecting means 14, and reference numeral 14c a cable for inputting therethrough the detection signal outputted from the insertion detected means 14 (switch 14a) to the controller 13.

The switch 14a is a mechanical ON/OFF switch having an open/close mechanism that is opened and closed by pressure, and the open/close mechanism is the unlock-type which is put in the OFF (open) state when no pressure is applied. As shown in FIG. 4, when the power cord plug 5 is inserted into the connecting member 10, the operation part of the switch 14a provided in the connecting member 10 contacts with the contact pieces of the power cord plug 5, and puts under pressure to close the switch open/close mechanism. The closing of the switch 14a allows the detection signal to be sent to the controller 13 through the cable 14c. With such a simple mechanism, the insertion detecting means 14 can be constructed to enable the controller to detect and recognize the insertion of the power cord plug 5.

FIG. 5 is an explanatory drawing showing the diagrammatic cross section of the insertion detecting means built in the connecting member 10. The switch 14a of the insertion detecting means 14 shown in FIG. 14 is substituted for an optical sensor 14b. The optical sensor 14b consists of a radiative device and a photo detector for light or infrared rays, and it is constructed so that the contact pieces of the power cord plug 5 are inserted between the radiative device and the photo detector. In the insertion detecting means 14 using the optical sensor 14b, when the power cord plug 5 is inserted into the connecting member 10, the contact pieces of the power cord plug 5 intercept the output (emitted light) from the radiative device to prevent it from being irradiated on the photo detector, thereby detecting the insertion of the power cord plug 5 without relying on a moving mechanism.

As described above, according to the first embodiment, when the power cord plug 5 of the device 2 is inserted into the receptacle 1, the house code A outputted to the power line 4 from the receptacle 1 is taken in and set thereto. This eliminates the operation for the user to set the house code A in the device 2, and permits automatic and accurate setting of the house code A, preventing a malfunction due to the wrong setting of the house code of the device 2.

Further, the device 2 receives the house code A only for a predetermined time since the insertion of the power cord plug 5, thereby preventing the reception of the house code sent from the device or the like in a neighboring house, and the setting of a wrong house code.

### Second Embodiment

The basic construction of the home network system according to the embodiment 2 is similar to that described in the first embodiment referring to FIG. 1 and FIGS. 3 to 5. In the second embodiment, like reference numerals as FIG. 1 and FIGS. 3 to 5 indicate like components and therefore the description thereof is omitted for brevity's s sake.

Now, the operation of the home network system of the second embodiment will be described.

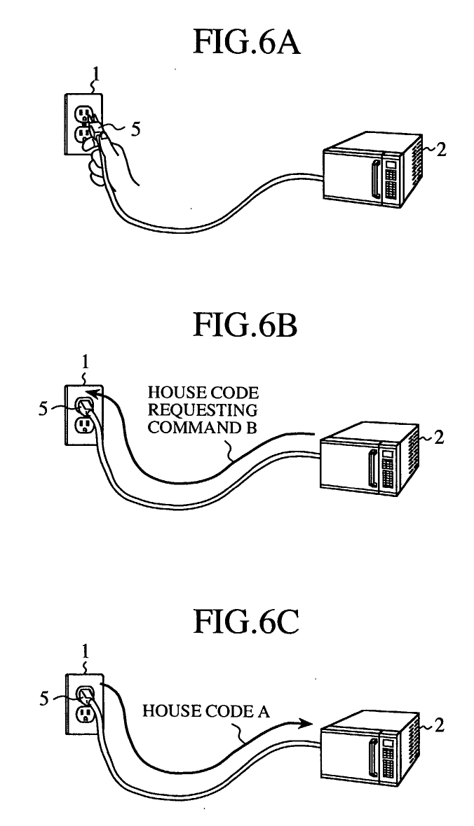

FIG. 6 is an explanatory drawing showing the connection of the device 2 to the receptacle 1 according to the second embodiment of the invention, and the communication therebetween. In FIG. 6, reference character B denotes a house code request command outputted from the device 2. As shown in FIG. 6A, when the power cord plug 5 of the device 2 is connected to the receptacle 1, the power source power is supplied to the device 2, and each control means or the like provided in the device 2 is activated. The device 2 uses the power line superposition interface (not shown) or the like activated by the power supply to output the house code request command B to the receptacle 1 through the power cord plug 5 (power cord) for superposition to the power line 4. The receptacle 1 having connected thereto the device 2 is put in a state ready for the reception of the house code request command B by the control of the controller 13 for a predetermined time since the connection. This is because the receptacle 1 is prevented from receiving the house code request command issued by the device provided in a neighboring house or the like, and because the reception of the house code request command B issued by the device 2 is ensured.

The power line communication modem 11 having received, from the contact pieces of the power cord plug 5, the house code request command B superposed on the power line 4 sends the house code request command B to the controller 13. The controller 13 having inputted therein the house code request command B reads the house code A from the memory 12, and outputs the house code A to the power line 4 for superposition by using the power line communication modem 11.

The house code A superposed on the power line 4 is taken in by the power line superposition interface provided in the device 2, as shown in FIG. 6C, and installed as the house code of the device 2. The installation is allowed only for a predetermined time since the insertion of the power cord plug 5 into the receptacle 1. Thus, when another house code of a neighboring house or the like is outputted to the power line 4 from the receptacle provided in the neighboring house or the like, it must be beware not to take in it. In this way, the device 2 automatically acquires the house code A, and thereafter, in the communication on the home network, information communication between each device and mutual settings are performed using the house code A (if the X10 protocol is adopted, a start code, a function code for setting the specification/recognition or the operation of the device 2, and the like are appended along with the house code A as communication information). The information communication and mutual setting also allows each setting (registration to network or the like) done between the host device 3 and the device 2 as shown in FIG. 1.

As described above, according to the second embodiment, when the power cord plug 5 of the device 2 is inserted into the receptacle 1, the house code request command B is sent from the device 2 to the receptacle 1, which superposes the house code A on the power line 4 upon reception of the house code request command B, and the device 2 takes in the house code A superposed on the power line 4 and sets it as the house code thereof. This eliminates the operation by the user to set the house code A in the device 2, and allows automatic and reliable setting of the house code A when the device 2 is activated, preventing the malfunction due to wrong setting of the house code of the device 2.

Further, since the receptacle 1 accepts the house code request command B only for a predetermined time since the insertion of the power cord plug 5 of the device 2 and does not the house code request command issued by the device provided in a neighboring house or the like, thereby enabling the house code request command B issued by the device 2 to be received with reliability.

Furthermore, since the device 2 accepts the house code A only for a predetermined time since the insertion of the power cord plug 5 into the receptacle 1 and does not the house code issued by the receptacle of a neighboring house or the like, thereby enabling the house code A issued by the receptacle 1 to be received with reliability.

### Third Embodiment

The basic construction of the home network system according to the third embodiment is similar to that described in the first embodiment referring to FIG. 1 and FIGS. 3 to 5. In the third embodiment, like reference numerals as FIG. 1 and FIGS. 3 to 5 indicate like components and therefore the description thereof is omitted for brevity's sake.

Now, the operation of the house network of the third embodiment will be described.

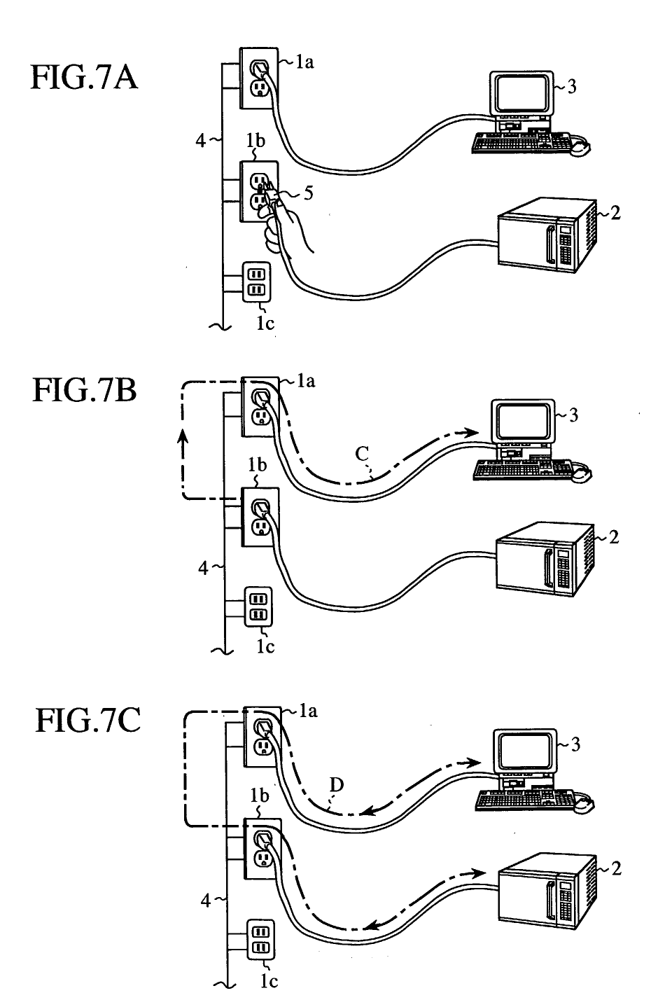

FIG. 7 is an explanatory drawing showing the communication performed between a device 2 performing power line superposition communication through a power line 4, a receptacle 1b to which the device 2 is connected, and a host device 3 managing the device 2 and the like through the power line 4 (and through a receptacle 1a to which the host device 3 is connected).

Referring to FIG. 7, reference numeral 1a denotes a receptacle which has the same construction as the receptacle 1 shown in FIGS. 3 to 5 and to which the host device 3 is connected, reference numeral 1b a receptacle which has the same construction as the receptacle 1 shown in FIGS. 3 to 5, and reference numeral 1c a receptacle having the same construction as the receptacle 1, as shown in FIGS. 3 to 5. These receptacles 1a, 1b, and 1c are connected together by the power line 4, respectively. Reference numeral C denotes information sent from the receptacle 1b to the host device 3 by power line superposition, and reference numeral D information communicated between the host device 3 and the device 2 by power line superposition.

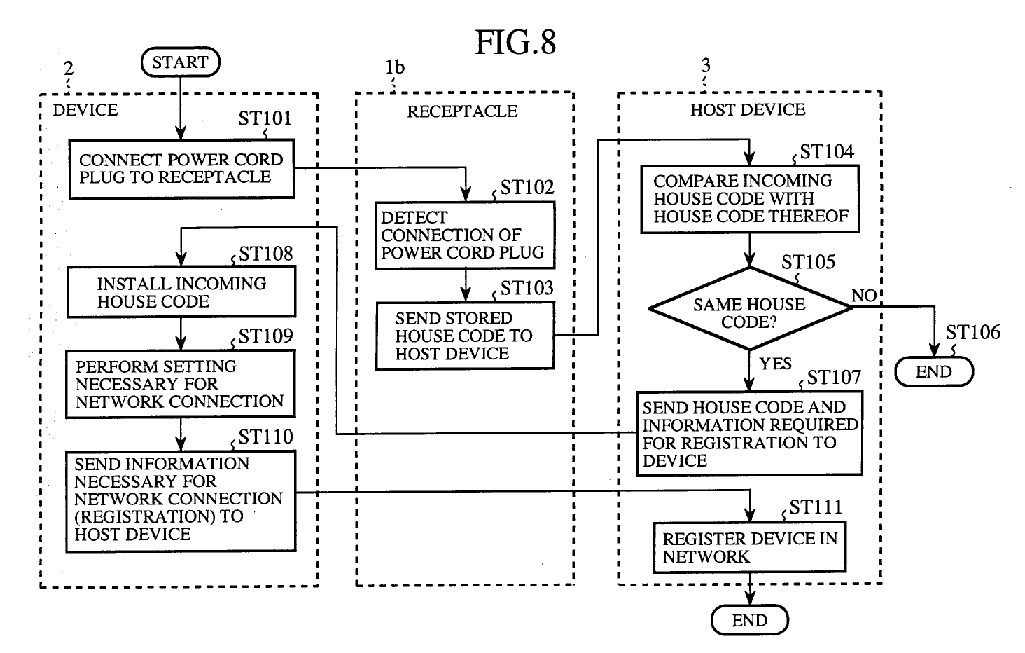

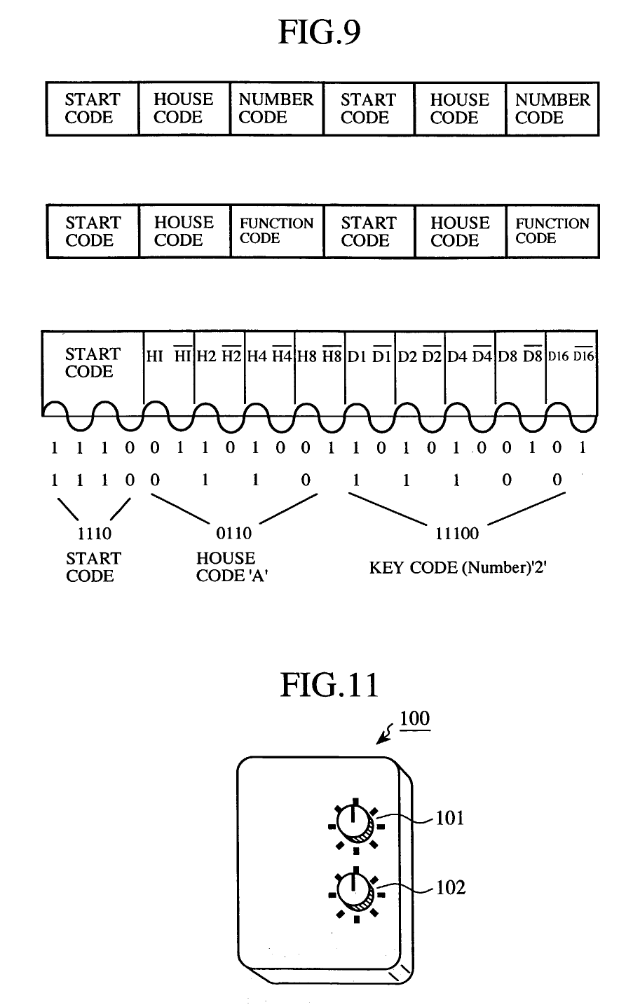

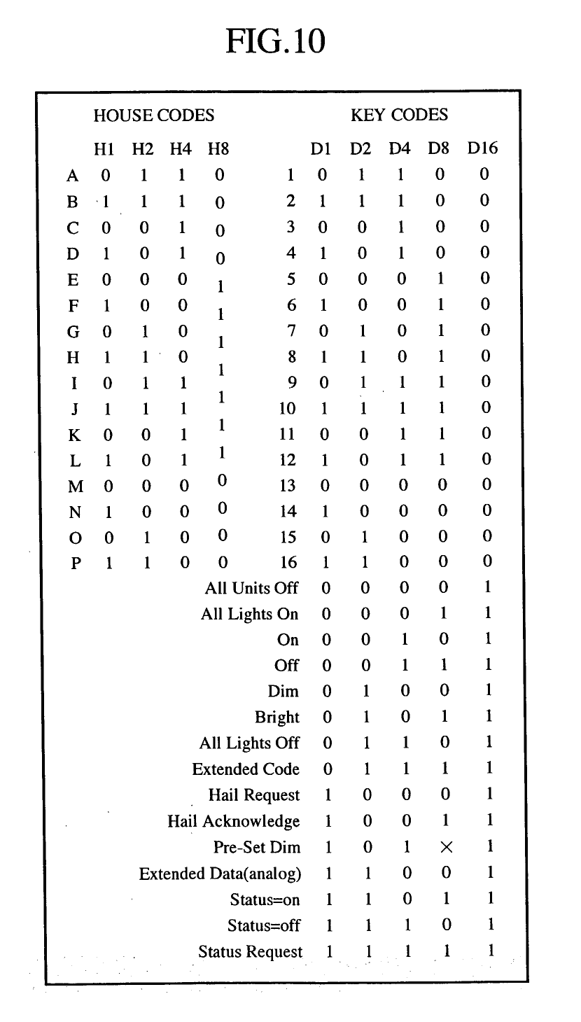

FIG. 8 is a flowchart showing the communication performed between the receptacle 1b, to which the device 2 is connected, and the host device 3, and the processing executed based on this communication. The communication and each processing are described referring to the flowchart of FIG. 8. As shown in FIG. 7A, when the power cord plug 5 of the device 2 is connected to the receptacle 1b (step ST101), the insertion detecting means 14 shown in FIG. 3 detects the insertion of the power cord plug 5 (step ST102), and the controller 13, to which the detection signal is inputted, outputs the house code stored in the memory 12 and information indicative of the connection of some device (in this case, the device 2) to the home network to the power line 4 by using the power line communication modem 11 (step ST103). A series of information outputted to the power line 4 is called as information C. The information C superposed on the power line is taken into the host device 3 whose power cord plug (power cord) is previously connected to the receptacle 1a, as shown in FIG. 7B.

The host device 3 compares the house code contained in the information C with the information (house code) held in the host device 3 (step ST104), and determines whether or not they are the same (step ST105). If they are not the same, the succeeding processing is not executed (step ST106). Otherwise, it recognizes that a new terminal device (device 2) is connected to the home network managed thereby, and it outputs each setting data or the like required for the network registration and information D consisting of each setting data plus the particular house code to the power line 4, as shown in FIG. 7C (step ST107).

The device 2, which has taken in the information D transmitted by superposition on the power line 4 through the power line superposition interface, installs the house code contained in the information D (step ST108), and performs its own setting necessary for the registration and connection to the home network based on other contents of the information D (step ST109). In this processing, the device 2 accepts the information D only for a predetermined time and does not the information issued from the host device of a neighboring house or the like, so that it can receive the information D issued by the host device 3 with reliably. Thereafter, the device 2 appends data (information) required for the network registration to the above house code and outputs it to the power line 4 (step ST110) to send it back to the host device 3 through the communication path via which the information D has come. In this way, the device 2 appropriately performs the power line superposition communication for the network registration between the host device 3 and the registration and each setting so that they mutually operate as a home network (step ST11).

As described above, according to the third embodiment, when the power cord plug 5 of the device 2 is inserted into the receptacle 1b, the host device 3 takes in the information C outputted to the power line 4 by the receptacle 1b, recognizes the connection of the new device 2, and performs the communication to register the device 2 in the home network. This eliminates the registration work when the user newly connects the device 2 to the network, the house code stored in the receptacle 1b can automatically be set in the device 2 connected to the receptacle 1b, and the device 2 can automatically be registered in the host device 3 managing the home network, preventing failures such as wrong setting of the house code of the device 2, and malfunction due to wrong setting of the host device 3 or omission in registration.

Further, since the device 2 accepts the information D sent from the host device 3 only for a predetermined time since the insertion of the power cord plug 5 into the receptacle 1 and does not the information issued by the host device in a neighboring house or the like, thereby preventing the setting of a wrong house code, and wrong network registration from being performed.

What is claimed is:

1. A home network system for performing communication using a power line, comprising:
a receptacle for power supply for superposing a house code previously assigned for each home on said power line upon detection of the insertion of a power cord plug; and
a terminal for receiving the house code superposed on said power line after the insertion of said power cord plug, and setting it as the house code thereof.

2. The home network system according to claim 1, wherein the terminal receives the house code only for a predetermined time since the insertion of the power cord plug.

3. The home network system for performing communication using a power line, comprising:
a terminal for superposing on said power line a house code request command requesting the sending of a house code previously assigned for each home by insertion of the power cord plug; and
a receptacle for power supply for superposing said house code on said power line, when the insertion of said power cord plug is detected and the house code request command superposed on said power line is received;
wherein said terminal receives the house code superposed on said power line, and sets it as the house code thereof.

4. The home network system according to claim 3, wherein the receptacle receives the house code request command only for a predetermined time since the detection of the insertion of the power cord plug, and
the terminal receives the house code only for a predetermined time since the insertion of the power cord plug.

5. The home network system according to claim 3, wherein the receptacle comprises:
insertion detecting means for detecting the insertion of a power cord plug;
memory means for storing therein a house code previously assigned for each home;
power line superposition communication means for performing communication through a power line; and
control means for reading the house code stored in said memory when said insertion detecting means detects the insertion of said power cord plug and said power line superposition communication means receives the house code request command superposed on the power line, and superposing the read house code on said power line by using said power line superposition means.

6. The home network system for performing communication using a power line, comprising:
a receptacle for power supply for superposing a house code previously assigned for each home on said power line upon detection of the insertion of a power cord plug;
a host terminal for receiving the house code superposed on said power line, comparing it with the house code held by said host terminal, and superposing said house code and the setting data necessary for home network registration on said power line when the received house code is the same as the house code held by said host terminal; and
a terminal for receiving the house code and the setting data superposed on the power line by said host terminal after the insertion of said power cord plug, setting it as the house code thereof, and performing the setting necessary for home network registration.

7. The home network system according to claim 6, wherein the terminal receives the house code and the setting data superposed on the power line by the host terminal only for a predetermined time since the insertion of the power cord plug.

8. The home network system according to claim 1, wherein the receptacle comprises:
insertion detecting means for detecting the insertion of a power cord plug;
memory means for storing therein a house code previously assigned for each home;
power line superposition communication means for performing communication through a power line; and
control means for reading the house code stored in said memory means when said insertion detecting means detects the insertion of said power cord plug, and superposing the read house code on said power line by using said power line superposition communication means.

9. The home network system according to claim 5, wherein the insertion detecting means detects the insertion of the power cord plug by using an unlock-type switch.

10. The home network system according to claim 8, wherein the insertion detecting means detects the insertion of the power cord plug by using an unlock-type switch.

11. The home network system according to claim 5, wherein the insertion detecting means detects the insertion of the power cord plug by using an optical sensor.

12. The home network system according to claim 8, wherein the insertion detecting means detects the insertion of the power cord plug by using an optical sensor.

13. The home network system according to claim 5, wherein the insertion detecting means detects the insertion of the power cord plug by change in the power line impedance when the power cord plug is inserted.

14. The home network system according to claim 8, wherein the insertion detecting means detects the insertion of the power cord plug by change in the power line impedance when the power cord plug is inserted.
